(19) United States
(12) Patent Application Publication
(10) Pub. No.: US 2025/0362410 A1
(43) Pub. Date: Nov. 27, 2025

(54) TRACKING OBJECTS USING LIGHT SIGNALS

(71) Applicant: SIGNIFY HOLDING B.V., EINDHOVEN (NL)

(72) Inventors: HARRY BROERS, 'S-HERTOGENBOSCH (NL); JAN EKKEL, OSS (NL)

(21) Appl. No.: 18/872,881

(22) PCT Filed: Jun. 12, 2023
(86) PCT No.: PCT/EP2023/065632

§ 371 Date: Dec. 9, 2024

Related U.S. Application Data
(60) Provisional application No. 63/352,332, filed on Jun. 15, 2022.

(30) Foreign Application Priority Data
Jul. 7, 2022 (EP) 22183639.8

(51) Int. Cl. G01S 17/66; G01S 7/481; G01S 7/487

(52) U.S. Cl. CPC G01S 17/66; G01S 7/4813; G01S 7/4873

(57) ABSTRACT

A method for tracking an object in a volume of space can include, iteratively for multiple time periods in a cycle, transmitting, by a communication apparatus, a light signal toward the object located in the volume of space, where the light signal is transmitted in a locational path of movement within the volume of space during the time period. The method can also include receiving, by the communication apparatus, a reflected signal of the light signal, where the reflected signal is a reflection of the light signal that originates from a reflective device of the object. The method can further include determining, using the communication apparatus, a location and a path of the object in the volume of space based on information obtained from the reflected signals.

### TECHNICAL FIELD

The present disclosure relates generally to tracking objects, and more particularly to systems, methods, and devices for tracking objects using light signals.

### BACKGROUND

Light fidelity (LiFi) and other optical communication technologies can be used to locate one or more objects in a volume of space. However, to the extent that an object in that volume of space moves, these optical communication technologies can have difficulties in tracking these objects. Also, when there are multiple objects to track at one time, the available bandwidth with optical communication technologies can become limited.

### SUMMARY

In general, in one aspect, the disclosure relates to a method for tracking an object in a volume of space. The method can include transmitting, by a communication apparatus during a first time period, a first light signal toward the object located in the volume of space, where the first light signal is transmitted in a locational path of movement within the volume of space during the first time period. The method can also include receiving, by the communication apparatus, a first reflected signal during the first time period, where the first reflected signal is a reflection of the first light signal that originates from a reflective device of the object. The method can further include transmitting, by the communication apparatus during a second time period, a second light signal toward the object located in the volume of space, where the second light signal is transmitted in the locational path of movement within the volume of space during the second time period, where the second time period proceeds the first time period, and where the first time period and the second time period are separated from each other by a non-zero time interval. The method can also include receiving, by the communication apparatus, a second reflected signal during the second time period, where the second reflected signal is a reflection of the second light signal that originates from the reflective device of the object. The method can further include determining, using the communication apparatus, a location and a path of the object in the volume of space based on first information obtained from the first reflected signal and second information obtained from the second reflected signal.

In another aspect, the disclosure relates to a communication apparatus for tracking an object in a volume of space. The communication apparatus can include a transmitter that is configured to send a plurality of light signals into the volume of space. The communication apparatus can also include a receiver that is configured to receive a plurality of reflected signals, where each of the plurality of reflected signals are reflections of one of the plurality of light signals that originate from a reflective device of the object. The communication apparatus can further include a controller communicably coupled to the transmitter and the receiver. The controller can be configured to control the transmitter to send each of the plurality of light signals to target locational paths of movement within the volume of space for one of a plurality of time periods in a cycle, where adjacent time periods when the plurality of light signals are sent toward the object are separated from each other by a non-zero time interval. The controller can also be configured to determine, using information obtained from each of the plurality of reflected signals, a location and a path of the object in the volume of space during the cycle.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 shows a block diagram of a system according to certain example embodiments;

FIG. 2 shows a detector of FIG. 1;

FIG. 3 shows a block diagram of a communication apparatus of FIG. 1;

FIG. 4 shows a block diagram of a controller of the communication apparatus of FIG. 3;

FIG. 5 shows a computing device in accordance with certain example embodiments;

FIG. 6 shows a flowchart of a method for tracking multiple objects in a volume of space according to certain example embodiments;

FIG. 7 shows a block diagram of a system used as part of an example for tracking multiple objects in a volume of space according to certain example embodiments;

FIGS. 8 through 10 each shows movement of a light signal relative to a detector within part of a cycle according to certain example embodiments;

FIGS. 11 through 13 show block diagrams of a system used as part of the example of FIG. 7 for tracking multiple objects in a volume of space according to certain example embodiments;

FIGS. 14 through 16 different examples of paths of movement of light signals relative to detectors within a cycle according to certain example embodiments;

FIG. 17 shows a graph of a light signal transmitted toward two objects during a cycle according to certain example embodiments.

### DETAILED DESCRIPTION

In general, example embodiments provide systems, methods, and devices for tracking one or more objects using light signals. Example embodiments can provide a number of benefits. Such benefits can include, but are not limited to, more accurate collection, interpretation, and use of data tracking one or more objects in a volume of space, use of existing lighting systems and/or other systems (e.g., security systems, fire protection systems), user control, and increased energy and storage efficiency. Example embodiments can be used with new communication apparatus that have light communication capabilities or with existing communication apparatus that are retrofit to comport with example embodiments.

Example communication apparatuses (including components thereof) can be made of one or more of a number of suitable materials to allow the electrical device to meet certain standards and/or regulations while also maintaining operational proficiency. Examples of such materials can include, but are not limited to, aluminum, stainless steel, fiberglass, glass, plastic, polymer, ceramic, and rubber. The National Electric Code (NEC), the National Electrical Manufacturers Association (NEMA), the International Electrotechnical Commission (IEC), the Federal Communication Commission (FCC), Underwriters Laboratories (UL), and the Institute of Electrical and Electronics Engineers (IEEE) are examples of entities that set standards and/or regulations that can apply to an example communication apparatus. Use of example embodiments described herein meet (and/or allow a communication apparatus to meet) such standards and/or regulations when applicable.

In the foregoing figures showing example embodiments of tracking objects using light signals, one or more of the components shown may be omitted, repeated, and/or substituted. Accordingly, example embodiments of tracking objects using light signals should not be considered limited to the specific arrangements of components shown in any of the figures. For example, features shown in one or more figures or described with respect to one embodiment can be applied to another embodiment associated with a different figure or description.

If a component of a figure is described but not expressly shown or labeled in that figure, the label used for a corresponding component in another figure can be inferred to that component. Conversely, if a component in a figure is labeled but not described with respect to that figure, the description for such component can be substantially the same as the description for a corresponding component in another figure. The numbering scheme for the various components in the figures herein is such that each component is a three-digit number or a four-digit number, and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of tracking objects using light signals will be described more fully hereinafter with reference to the accompanying drawings, in which example embodiments of tracking objects using light signals are shown. Tracking objects using light signals may, however, be embodied in many different forms and should not be construed as limited to the example embodiments set forth herein. Rather, these example embodiments are provided so that this disclosure will be thorough and complete, and will fully convey the scope of tracking objects using light signals to those of ordinary skill in the art. Like, but not necessarily the same, elements (also sometimes called components) in the various figures are denoted by like reference numerals for consistency.

Terms such as “first”, “second”, “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. Such terms are not meant to denote a preference or a particular orientation. Such terms are not meant to limit embodiments of tracking objects using light signals. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

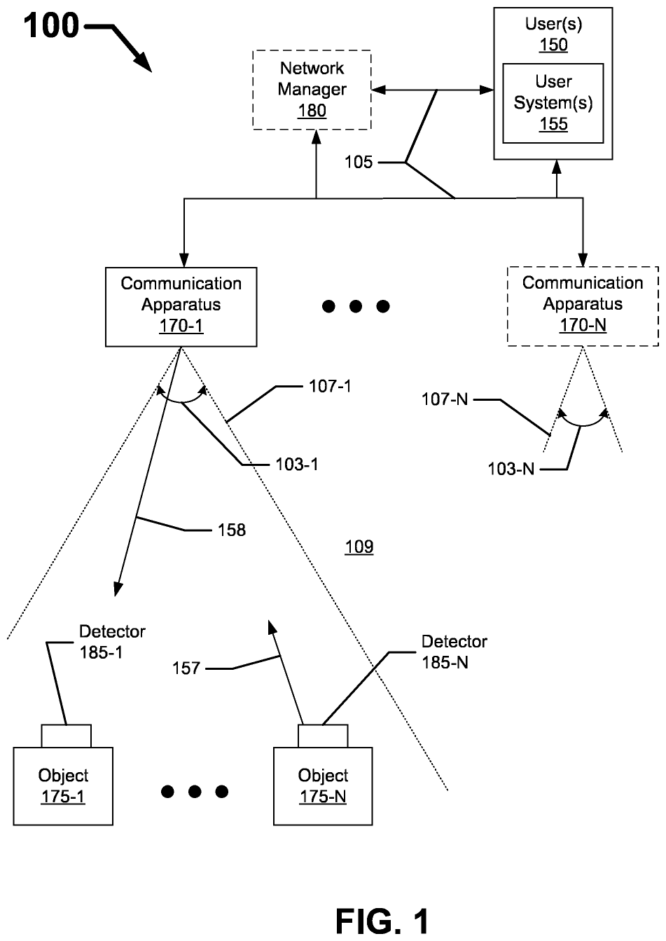

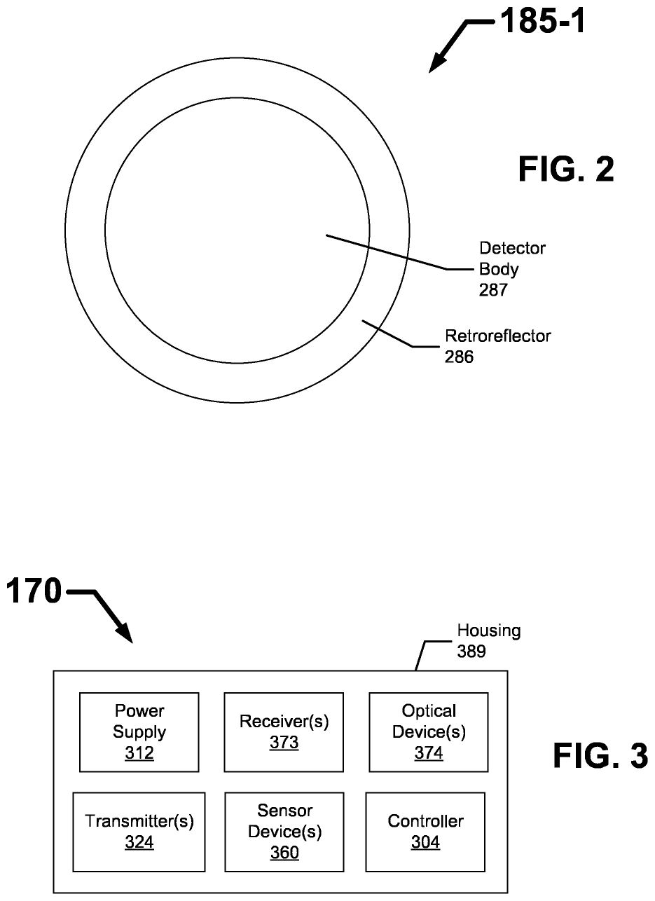

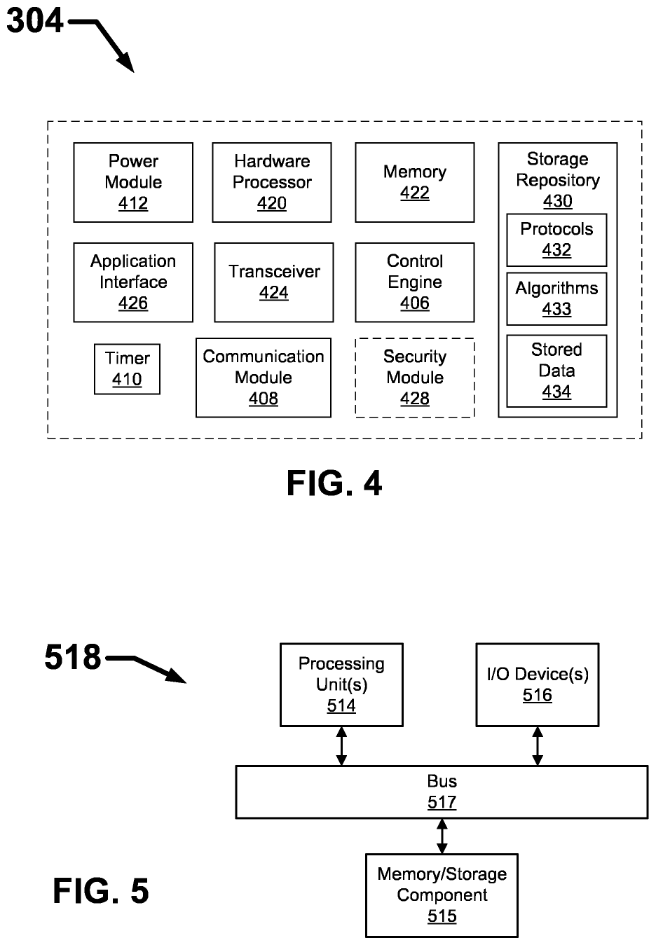

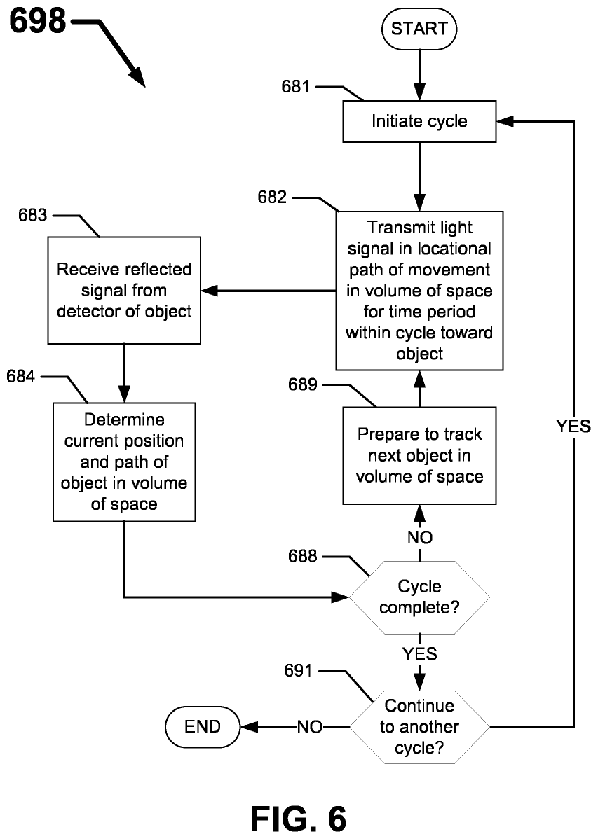

FIG. 1 shows a block diagram of a system 100 according to certain example embodiments. FIG. 2 shows a detector 185-1 of FIG. 1. FIG. 3 shows a block diagram of a communication apparatus 170-1 of FIG. 1. FIG. 4 shows a block diagram of the controller 304 of the communication apparatus 170-1 of FIG. 3. Referring to FIGS. 1 through 4, the system 100 includes an optional network manager 180, one or more users 150 (which can include one or more user systems 155), one or more objects 175 (e.g., object 175-1, object 175-N), and multiple communication apparatuses 170 (e.g., communication apparatus 170-1, communication apparatus 170-N).

The one or more objects 175 and at least part of the communication apparatuses 170 are located in a volume of space 109. The components shown in FIGS. 1 through 4 are not exhaustive, and in some embodiments, one or more of the components shown in FIGS. 1 through 4 may not be included in the system 100. Any component of the system 100 can be discrete or combined with one or more other components of the system 100. For example, a sensor device 360 can be a separate component of the system 100 that is communicably coupled to a communication apparatus 170.

An object 175 can be a person, an item, an entity, and/or other thing that is located in the volume of space 109. Examples of an object 175 can include, but are not limited to, a consumer, an employee, an inventory item, a piece of furniture, a vehicle (e.g., a forklift), production tools/machinery (e.g., an electronic screwdriver), medical equipment (e.g., surgical devices, monitoring equipment), a pallet, a robot, and a piece of office equipment (e.g., laptop computer, telephone). An object 175 can be stationary or moving in the volume of space 109. If an object 175 is moving, the movement of the object 175 can be at any rate (e.g., random, constant), any direction (e.g., constant, random), and for any amount of time. The system 100 has any number of objects 175. In this case, there are N objects 175.

In cases where there is only one object 175 in the volume of space 109 during a cycle, a communication apparatus 170 (e.g., communication apparatus 170-1) can send multiple light signals 158 to track the object 175 in the cycle, where each light signal 158 has a duration of a time period within the cycle. In such a case, there can be a non-zero time interval (e.g., 10 microseconds, 45 milliseconds, 1 second) between adjacent time periods during which a light signal 158 is not directed toward the object 175.

Each object 175 has a detector 185 coupled to, integrated with, or otherwise affixed to that object 175. For example, in this case, detector 185-1 is coupled to object 175-1, and detector 185-N is coupled to object 175-N. As in this example, each object 175 can have a single detector 185. In alternative embodiments, an object 175 can have multiple detectors 185. A detector 185 can have any of a number of forms, including but not limited to an integrated device that is part of a surface of an object 175, and a sticker stuck on an object 175, and a badge worn by an object 175.

A detector 185 of an object 175 can have any of a number of configurations. For example, a detector 185 can be configured to receive light signals 158 used for communication. As another example, a detector 185 can be configured to receive and manipulate light signals 158 that are used for alignment or positioning. An example of a detector 185-1 is shown in FIG. 2. In that case, the detector 185-1 has a detector body 287 (e.g., configured to receive light signals 158 used for communication, instructions, etc.) that has a substantially circular top surface. Surrounding the detector body 287 of the detector 185-1 is a retroreflector 286 (e.g., configured to receive and manipulate light signals 158 that are used for alignment or positioning), also with a substantially circular top surface.

The retroreflector 286 can be configured to reflect a light signal 158 (e.g., a light signal emitted by a communication apparatus 170) as a reflected signal 157 back in substantially the same direction in which the light signal was received. In addition to or as an alternative to a retroreflector 286, the detector 185-1 can be or include some other component that has a reflective quality that is configured to reflect light signals 158 as reflected signals 157. In alternative embodiments, the detector 185-1 can include multiple retroreflectors 286 that are located in various positions relative to the detector body 287.

The network manager 180 is a device or component that controls all or a portion of the system 100, including the communication apparatuses 170 that are communicably coupled to the network manager 180 via one or more communication links 105. The network manager 180 can include a controller (e.g., similar to the controller 304 of a communication apparatus 170) and an optional user interface. In such a case, the controller of the network manager 180 can include some or all of the same components and/or perform some or all of the same functionality as the controller 304 of a communication apparatus 170. The network manager 180 (or components thereof) can be located in or near the volume of space 109. In addition, or in the alternative, the network manager 180 (or components thereof) can be located remotely from (e.g., in the cloud) the volume of space 109. The network manager 180 can be called by any of a number of other names, including but not limited to a master controller, an enterprise manager, and a network controller.

A user 150 can be any person that interacts, directly or indirectly, with the network manager 180, a communication apparatus 170, and/or any other component of the system 100. Examples of a user 150 may include, but are not limited to, a business owner, an engineer, a company representative, a consultant, a contractor, a security entity, and a manufacturer's representative. A user 150 can use one or more user systems 155, which may include a display (e.g., a GUI). Examples of a user system 155 can include, but are not limited, to, a smart phone, a smart watch, an electronic tablet, a laptop computer, and a desktop computer. A user system 155 of a user 150 can interact with (e.g., send data to, obtain data from) the network manager 180, a communication apparatus 170, and/or any other component of the system 100 via an application interface and using the communication links 105. The user 150 can also interact directly with the network manager 180, a communication apparatus 170, and/or any other component of the system 100 through a user interface (e.g., keyboard, mouse, touchscreen).

Interaction between each communication apparatus 170 (including components thereof), the users 150 (including any associated user systems 155), the network manager 180, and other components of the system 100 can be conducted using communication links 105. Each communication link 105 can include wired (e.g., Class 1 electrical cables, Class 2 electrical cables, electrical connectors, Power Line Carrier, RS485) and/or wireless (e.g., line-of-sight, Wi-Fi, Zigbee, visible light communication, cellular networking, Bluetooth, Bluetooth Low Energy (BLE), ultrawide band (UWB), WirelessHART, ISA100) technology. A communication link 105 can transmit signals (e.g., light signals 158, reflected signals 157, radio frequency signals) that include any type of data (e.g., communication, control, location, updates) between each communication apparatus 170 (including components thereof, such as the controller 304 and a sensor device 360), the users 150 (including any associated user systems 155), the network manager 180, and any other components of the system 100.

Each example communication apparatus 170 is configured to send light signals 158 and receive reflected signals 157 within a light signal range 107. A light signal range 107 can be defined by an angle 103 that has an origination point at the communication apparatus 170 (or portion thereof). The light signal range 107 (and so also the angle 103) can be fixed or adjustable (e.g., as by the controller 304 of the communication apparatus 170, discussed below). Each light signal range 107 is at least partially located within the volume of space 109. A light signal range 107 can correspond to a portion (e.g., a partial portion, the entire portion) of the volume of space 109. In some cases, a communication apparatus 170 is stationary within the volume of space 109. In alternative cases, a communication apparatus 170 is moving or movable within the volume of space 109.

If a detector 185 of an object 175 (e.g., detector 185-1 of object 175-1, detector 185-N of object 175-N) is within a light signal range 107 (e.g., light signal range 107-1) of a communication apparatus 170 (e.g., communication apparatus 170-1), and if the detector 185 of the object 175 is within a line-of-sight of the communication apparatus 170, then the detector 185 of the object 175 and the communication apparatus 170 can transmit light signals 158 and reflected signals 157 between each other. In this case, at the point in time captured in FIG. 1, detector 185-N of object 175-N is beginning to send reflected signal 157 toward the communication apparatus 170-1, and the communication apparatus 170-1 is beginning to send a light signal 158 toward the detector 185-1 of object 175-1. A light signal 158 that is sent by a communication apparatus 170 can have any of a range of diameters. In some cases, the diameter of a light signal 158 can be based, at least in part, on the size of the detector 185 (or portion thereof, such as the retroreflector 286) to which the light signal 158 is directed.

In this example, communication apparatus 170-1 has a light signal range 107-1, which is defined by an angle 103-1, and communication apparatus 170-N has a light signal range 107-N, which is defined by an angle 103-N. In some cases, when there are multiple communication apparatuses 170 in the system 100, the light signal range 107 of one communication apparatus 170 can overlap with the light signal range 107 of at least one adjacent communication apparatus 170. Alternatively, when the system 100 has multiple communication apparatuses 170, there can be no overlap between any adjacent light signal ranges 107. The angle 103 of one light signal range 107 can be the same as, or different than, the angle 103 of one or more other light signal ranges 107 in the system 100. A communication apparatus 170 can include one or more of a number of components. For example, as shown in FIG. 3, a communication apparatus 170 can include a housing 389 that has disposed therein or thereon a power supply 312, one or more receivers 373, one or more transmitters 324, the controller 304, an optical device 374, and one or more sensor devices 360. In certain example embodiments, each communication apparatus 170 can also send and/or receive signals that are not light signals. Examples of such other types of signals can include, but are not limited to, radio frequency signals (e.g., using WiFi). When the system 100 includes multiple communication apparatuses 170, the configuration of one communication apparatus 170 can be the same as, or different than, one or more of the other communication apparatuses 170.

A communication apparatus 170 can be an independent device (as shown in FIG. 1). Alternatively, a communication apparatus 170 can be integrated with another electrical device (e.g., a luminaire, a control switch, a security camera, a smoke detector, a carbon monoxide detector, a wall switch. When a communication apparatus 170 is integrated with a luminaire, the luminaire can include a light fixture, a lighting device, and/or a lighting system. A luminaire has a principal purpose of providing general illumination to the volume of space 109. A luminaire can be any of type, including but not limited to recessed light fixtures (e.g., down can light fixtures), pendent lights, table lamps, troffers, emergency light fixtures, illuminated exit signs, parking lot light fixtures, streetlights, sidewalk light fixtures, and ceiling fan lights. Luminaires can use any type of lighting technology, including but not limited to light-emitting diodes (LEDs), incandescent, halogen, fluorescent, and sodium vapor.

When a communication apparatus 170 is an independent device, the communication apparatus 170 can include a housing 389. The housing 389 can include at least one wall that forms a cavity. In some cases, the housing 389 can be designed to comply with any applicable standards so that the communication apparatus 170 can be located in a particular environment of the volume of space 109. The housing 389 of a communication apparatus 170 can be used to house one or more components of the communication apparatus 170. In alternative embodiments, any one or more of these or other components of a communication apparatus 170 can be disposed on the housing 389 and/or remotely from the housing 389. For instance, a transmitter 324 (or portion thereof) can be disposed on or integrated with the housing 389 of a communication apparatus 170.

The power supply 312 of a communication apparatus 170 receives power from a power source (e.g., AC mains) and manipulates (e.g., transforms, rectifies, inverts) that power to provide the manipulated power to one or more other components (e.g., a receiver 373, the controller 304) of the communication apparatus 170, where the manipulated power is of a type (e.g., alternating current, direct current) and level (e.g., 12V, 24V, 120V) that can be used by the other components of the communication apparatus 170. The power supply 312 can include one or more of a number of single or multiple discrete components (e.g., transistor, diode, resistor, transformer), and/or a microprocessor. The power supply 312 may include a printed circuit board, upon which the microprocessor and/or one or more discrete components are positioned. In some cases, the power supply 312 can be or include a source of power in itself to provide signals to the other components of the communication apparatus 170. For example, the power supply 312 can be or include an energy storage device (e.g., a battery). As another example, the power supply 312 can be or include a localized photovoltaic power system.

A transmitter 324 of a communication apparatus 170 can send light signals 158 (e.g., used for tracking, used for communication). A transmitter 324 can also be used in some cases to transmit other types of signals (e.g., radio frequency signals). A transmitter 324 can use wired and/or wireless technology. In certain example embodiments, a communication apparatus 170 can have one transmitter 324 that is used for optical communication (e.g., using light signals 158) and another transmitter 324 that is used for wired/wireless communication (e.g., using radio frequency signals). A transmitter 324 can be configured in such a way that the light signals 158 (and/or other types of signals) are sent to sources (e.g., the detectors 185) located within the light signal range 107 and within a line-of-sight of those sources. A transmitter 324 can be controlled (e.g., by the controller 304) in such a way that one or more parameters (e.g., direction, diameter, time of transmission, movement, duration) of a light signal 158 can be set or adjusted, whether before or during a particular transmission of the light signal 158.

A transmitter 324 can include any of a number of components used to transmit light signals 158, including but not limited to a light source (e.g., a LED, a laser), a modulator, a pivot apparatus, a switch, a filter, and a reflector. When a transmitter 324 also sends other types of signals, the transmitter 324 can include other components, such as an antenna. A transmitter 324 can use one or more of any number of suitable communication protocols when sending light signals 158.

A receiver 373 of a communication apparatus receive reflected signals 157 (e.g., used for tracking), which are reflections of light signals 158. The receiver 373 can also be used in some cases to receive other types of signals (e.g., radio frequency signals). The receiver 373 can use wired and/or wireless technology. The receiver 373 can be configured in such a way that the reflected signals 157 (and/or other types of signals) are received from sources (e.g., the detectors 185) within the light signal range 107 and within a line-of-sight of those sources. A receiver 373 can be controlled (e.g., by the controller 304) in such a way that a reflected signal 157 can be received in such a way that the characteristics of the reflected signal 157 are optimized.

A receiver 373 can include any of a number of components used to receive reflected signals 157, including but not limited to a light detector, a light collector, a pivot apparatus, a switch, and a filter. A receiver 373 can include other components, such as an antenna. A receiver 373 can use one or more of any number of suitable communication protocols when receiving reflected signals 157.

An optical device 374 of a communication apparatus 170 can be or include one or more of a number of components that are configured to manipulate a light signal 158 sent by a transmitter 324 and/or a reflected signal 157 received by a receiver 373. Examples of a component of an optical device 374 can include, but are not limited to, a lens, a light guide, a mirror, and a prism. The one or more components of an optical device 374 can be fixed (e.g., in terms of position, in terms of function). Alternatively, one or more components (or portions thereof) of an optical device 374 can be adjusted (e.g., by the controller 304).

Each sensor device 360 of a communication apparatus 170 includes one or more sensors that measure one or more parameters (e.g., signal strength, a signal amplitude, angle of arrival, angle of departure, temperature, humidity, voltage, current, etc.). A parameter can be associated with the light signals 158 and/or the reflected signals 157. Examples of a sensor of a sensor device 360 can include, but are not limited to, a temperature sensor, a pressure sensor, an accelerometer, a gyroscope, a capacitive sensor, a magnetic sensor, a microphone, a voltmeter, an ammeter, and a camera. A sensor device 360 can be a stand-alone device or can be integrated with another component (e.g., a communication apparatus 170) of the system 100.

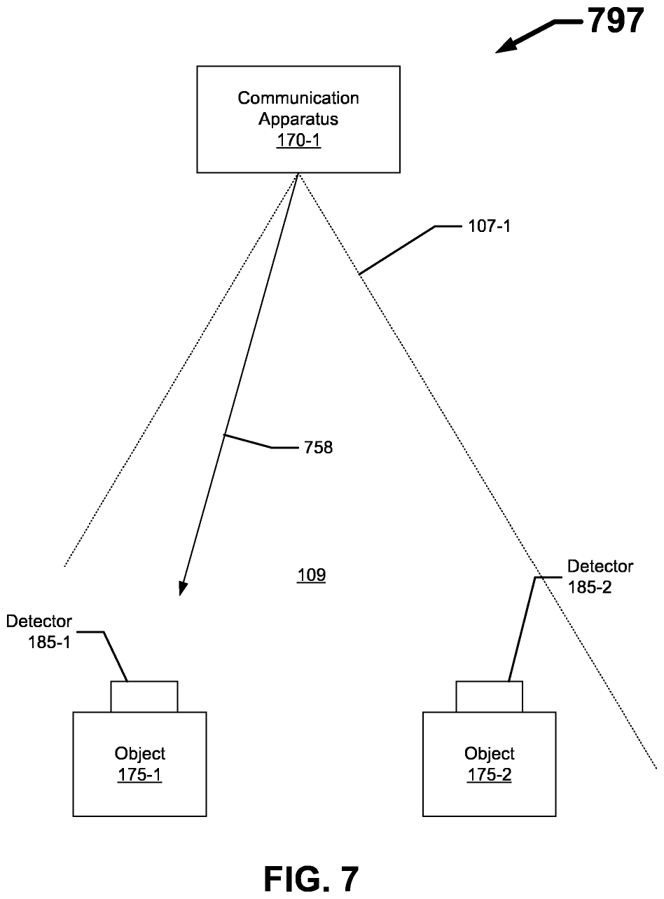

The controller 304 of a communication apparatus 170 can coordinate and/or control the other components (e.g., the power supply 312, a receiver 373, a sensor device 360, a transmitter 324, an optical device 374) of the communication apparatus 170. The controller 304 of a communication apparatus 170 can include one or more of a number of components. For example, as shown in FIG. 4, components of the controller 304 can include, but are not limited to, a control engine 406, a communication module 408, a timer 410, a power module 412, a storage repository 430, a hardware processor 420, a memory 422, a transceiver 424, an application interface 426, and, optionally, a security module 428. The controller 304 of a communication apparatus 170 can correspond to a computer system as described below with regard to FIG. 5.

As a specific example, the controller 304 can instruct a transmitter 324 to send one or more light signals 158 into the portion of the volume of space 109. This instruction provided by the controller 304 can include one or more of a number of parameters associated with a light signal 158, including but not limited to an intensity, a diameter, an amount of time, a direction, and a movement over the amount of time. As another example, the controller 304 can instruct the receivers 373 to capture the reflected signals 157 that are directed from the detectors 185. In addition, the controller 304 can extract information from the reflected signals 157 received by the receivers 373 to determine a location and a path of each object 157 in the portion (i.e., in the light signal range 107) of the volume of space 109. These determinations allow the controller 304 to track each of the objects 175 in the portion of the volume of space 109.

In embodiments, each communication apparatus 170 can be located in a predetermined position and/or fixed position within the volume of space 109. The predetermined position and/or fixed position of each communication apparatus 170 can be known by the network manager 180. The location of the communication apparatus 170 in the volume of space 109 can be used, along with the information obtained from the reflected signals 157 received from the detectors 185 at various points in time, by the network manager 180 to identify a location of the objects 175 within the portion of the volume of space 109 at a point in time and track the movement (e.g., speed, direction, pauses, inactivity) of those objects 175 over a period of time.

Alternatively, as with free space optical (FSO) situations, a communication apparatus 170 (or portion thereof) can be in motion while light signals 158 are sent by the communication apparatus 170 and/or while reflected signals 157 are received by the communication apparatus 170. In such a case, the location of the communication apparatus 170 at a certain point in time can be ascertained (e.g., a calculated location, a measured location) in real time so that the location and path of each object 175 in the volume of space 109 can be determined in real time.

The storage repository 430 of the controller 304 can be a persistent storage device (or set of devices) that stores software and data used to assist the controller 304 in communicating with the users 150 (including associated user systems 155), the network manager 180, and the controllers 304 of other communication apparatuses 170, if any, within the system 100. In one or more example embodiments, the storage repository 430 stores one or more protocols 432, one or more algorithms 433, and stored data 434. The protocols 432 of the storage repository 430 can be any procedures (e.g., a series of method steps) and/or other similar operational procedures that the control engine 406 of the controller 304 follows based on certain conditions at a point in time.

The protocols 432 can include any of a number of communication protocols that are used to send and/or receive data between the controller 304 of the network manager 180, the users 150 (including associated user systems 155), and the communication apparatuses 170. Such protocols 432 used for communication can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the protocols 432 can provide a layer of security to the data transferred within the system 100. Other protocols 432 used for communication can be associated with the use of optical communication, Wi-Fi, Zigbee, VLC, cellular networking, Bluetooth Low Energy (BLE), ultrawide band (UWB), and Bluetooth.

The algorithms 433 can be any formulas, mathematical models, forecasts, simulations, and/or other similar tools that the control engine 406 of the controller 304 uses to reach a computational conclusion. For example, one or more algorithms 433 can be used to determine where an object 175 is projected to be at a point in time (e.g., in the next cycle) in the future within the volume of space 109. As another example, one or more algorithms 433 can be used to determine the speed at which an object 175 moves in the volume of space 109 based on data received by a receiver 373 of a communication apparatus 170.

Stored data 434 can be any data associated with the communication apparatuses 170, the objects 175, the volume of space 109, the users 150 (including any associated user systems 155), data received and/or derived from the reflected signals 157 (and/or other types of signals received by the receivers 373), threshold values, tables, results of previously run or calculated algorithms 433, updates to protocols 432, user preferences, and/or any other suitable data. Such data can be any type of data, including but not limited to historical data, present data, and future data (e.g., forecasts). The stored data 434 can be associated with some measurement of time derived, for example, from the timer 410.

Examples of a storage repository 430 can include, but are not limited to, a database (or a number of databases), a file system, cloud-based storage, a hard drive, flash memory, some other form of solid state data storage, or any suitable combination thereof. The storage repository 430 can be located on multiple physical machines, each storing all or a portion of the protocols 432, the algorithms 433, and/or the stored data 434 according to some example embodiments. Each storage unit or device can be physically located in the same or in a different geographic location.

The storage repository 430 can be operatively connected to the control engine 406. In one or more example embodiments, the control engine 406 includes functionality to communicate with the users 150 (including associated user systems 155), the other communication apparatuses 170, the objects 175 (including the detectors 185 of those objects 175), and the network manager 180 in the system 100. More specifically, the control engine 406 sends information to and/or receives information from the storage repository 430 in order to communicate with the users 150 (including associated user systems 155), the other communication apparatuses 170, the objects 175 (including the detectors 185 of those objects 175), and the network manager 180. As discussed below, the storage repository 430 can also be operatively connected to the communication module 408 in certain example embodiments.

In certain example embodiments, the control engine 406 of the controller 304 controls the operation of one or more components (e.g., the communication module 408, the timer 410, the transceiver 424) of the controller 304. For example, the control engine 406 can activate the communication module 408 when the communication module 408 is in “sleep” mode and when the communication module 408 is needed to send data received from another component (e.g., a detector 185 of an object 175) in the system 100. The control engine 406 of the controller 304 can harvest information (e.g., a strength of a reflected signal 157 received from a detector 185, an angle of arrival of a reflected signal 157 received by a receiver 373) that can be used to locate and/or track multiple objects 175 in the volume of space 109 over a period of time (e.g., a cycle, multiple cycles).

As another example, the control engine 406 can have (as stored data 434 in the storage repository 430) a three-dimensional layout of the entire volume of space 109 (or a portion thereof), including the precise locations of each object detector 185 (and so also each object 175). The control engine 406 can use this information, as well as one or more protocols 432 and/or one or more algorithms 433, to analyze the location, trajectory, pace, and/or other characteristics of each of the detectors 185 (and so also each of the objects 175) within the volume of space 109 at a particular point in time. In some cases, the control engine 406 can determine, using one or more protocols 432 and/or one or more algorithms 433, whether failing to receive a reflected signal 157 from a retroreflector 286 of a detector 185 during part of a cycle is due to the light signal 158 landing entirely on the detector body 287 of the detector 185 as opposed to missing the detector 185 entirely.

The control engine 406 of the controller 304 of a communication apparatus 170 can generate and process data associated with reflected signals 157, control signals, communication signals, and/or other types of signals sent to and received from the users 150 (including associated user systems 155), other communication apparatuses 170, the network manager 180, and the detectors 185. The control engine 406 can control one or more of the receivers 373, one or more of the transmitters 324, and/or the one or more optical devices of a communication apparatus 170. In certain embodiments, the control engine 406 of the controller 304 can communicate with one or more components of a system external to the system 100. For example, the control engine 406 can interact with an inventory management system by ordering a replacement for a receiver 373 that is no longer functioning properly. In this way, the controller 304 is capable of performing a number of functions beyond what could reasonably be considered a routine task.

In certain example embodiments, the control engine 406 can include an interface that enables the control engine 406 to communicate with the other communication apparatuses 170, the detectors 185, the network manager 180, and the users 150 (including associated user systems 155). For example, if a user system 155 operates under IEC Standard 62386, then the user system 155 can have a serial communication interface that will transfer data to the controller 304 via the communication links 105. In such a case, the control engine 406 can also include a serial interface to enable communication with the user system 155. Such an interface can operate in conjunction with, or independently of, the protocols 432 used to communicate between the controller 304 and the users 150 (including corresponding user systems 155), the other communication apparatuses 170, the network manager 180, and the detectors 185.

The control engine 406 (or other components of the controller 304) can also include one or more hardware components and/or software elements to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I2C), and a pulse width modulator (PWM).

The communication module 408 of the controller 304 determines and implements the communication protocol (e.g., from the protocols 432 of the storage repository 430) that is used when the control engine 406 communicates with (e.g., sends signals to, receives signals from) the user systems 155, the other communication apparatuses 170, the network manger 180, and the detectors 185. In some cases, the communication module 408 accesses the stored data 434 to determine which communication protocol is used to communicate with another component of the system 100. In addition, the communication module 408 can identify and/or interpret the communication protocol of a communication received by the controller 304 so that the control engine 406 can interpret the communication. The communication module 408 can also provide one or more of a number of other services with respect to data sent from and received by the controller 304. Such services can include, but are not limited to, data packet routing information and procedures to follow in the event of data interruption.

The timer 410 of the controller 304 can track clock time, intervals of time, an amount of time, and/or any other measure of time. The timer 410 can also count the number of occurrences of an event, whether with or without respect to time. Alternatively, the control engine 406 can perform the counting function. The timer 410 is able to track multiple time measurements concurrently. The timer 410 can track time periods based on an instruction received from the control engine 406, based on an instruction received from a user 150, based on an instruction programmed in the software for the controller 304, based on some other condition or from some other component, or from any combination thereof. In certain example embodiments, the timer 410 can provide a time stamp for each reflected signal 157 that is reflected off of a detector 185.

The power module 412 of the controller 304 receives power from the power supply of the communication apparatus 170 and manipulates (e.g., transforms, rectifies, inverts) that power to provide the manipulated power to one or more other components (e.g., the timer 410, the control engine 406) of the controller 304, where the manipulated power is of a type (e.g., alternating current, direct current) and level (e.g., 12V, 24V, 120V) that can be used by the other components of the controller 304. The power module 412 can include one or more of a number of single or multiple discrete components (e.g., transistor, diode, resistor, transformer), and/or a microprocessor. The power module 412 may include a printed circuit board, upon which the microprocessor and/or one or more discrete components are positioned. In some cases, the power module 412 can include one or more components that allow the power module 412 to measure one or more elements of power (e.g., voltage, current) that is delivered to and/or sent from the power module 412. In addition, or in the alternative, the power module 412 can be or include a source of power in itself to provide signals to the other components of the controller 304. For example, the power module 412 can be or include an energy storage device (e.g., a battery). As another example, the power module 412 can be or include a localized photovoltaic power system.

The hardware processor 420 of the controller 304 executes software, algorithms, and firmware in accordance with one or more example embodiments. Specifically, the hardware processor 420 can execute software on the control engine 406 or any other portion of the controller 304, as well as software used by the users 150 (including associated user systems 155), the network manager 180, the other communication apparatuses 170, and/or the objects 175 (including the associated detectors 185). The hardware processor 420 can be an integrated circuit, a central processing unit, a multi-core processing chip, SoC, a multi-chip module including multiple multi-core processing chips, or other hardware processor in one or more example embodiments. The hardware processor 420 can be known by other names, including but not limited to a computer processor, a microprocessor, and a multi-core processor.

In one or more example embodiments, the hardware processor 420 executes software instructions stored in memory 422. The memory 422 includes one or more cache memories, main memory, and/or any other suitable type of memory. The memory 422 can include volatile and/or non-volatile memory. The memory 422 is discretely located within the controller 304 relative to the hardware processor 420 according to some example embodiments. In certain configurations, the memory 422 can be integrated with the hardware processor 420.

In some cases, the hardware processor 420 (or portion thereof) can be specialized or designed for particular applications. For example, a hardware processor 420 can be or include an artificial intelligence/machine learning (AI/ML) vector processor. As another example, a hardware processor 420 can be or include a floating point unit (FPU) in cases where a communication apparatus 170 (or portion thereof) moves while light signals 158 are sent by the communication apparatus 170 and/or while reflected signals 157 are received by the communication apparatus 170.

In certain example embodiments, the controller 304 does not include a hardware processor 420. In such a case, the controller 304 can include, as an example, one or more field programmable gate arrays (FPGA), one or more insulated-gate bipolar transistors (IGBTs), one or more integrated circuits (ICs). Using FPGAs, IGBTs, ICs, and/or other similar devices known in the art allows the controller 304 (or portions thereof) to be programmable and function according to certain logic rules and thresholds without the use of a hardware processor. Alternatively, FPGAs, IGBTs, ICs, and/or similar devices can be used in conjunction with one or more hardware processors 420.

The transceiver 424 of the controller 304 can send and/or receive control and/or communication signals. Specifically, the transceiver 424 can be used to transfer data between the controller 304 and the users 150 (including associated user systems 155), the other communication apparatuses 170, the network manager 180, and the objects 175 (including associated detectors 185). The transceiver 424 can use wired and/or wireless technology. The transceiver 424 can be configured in such a way that the control and/or communication signals sent and/or received by the transceiver 424 can be received and/or sent by another transceiver that is part of a user system 155, another communication apparatus 170, the network manager 180, and/or an object 175 (including an associated detector 185).

The transceiver 424 can send and/or receive any of a number of signal types, including but not limited to radio frequency signals. When the transceiver 424 uses wireless technology, any type of wireless technology can be used by the transceiver 424 in sending and receiving signals. Such wireless technology can include, but is not limited to, Wi-Fi, Zigbee, VLC, cellular networking, BLE, UWB, and Bluetooth. The transceiver 424 can use one or more of any number of suitable communication protocols (e.g., ISA100, HART) when sending and/or receiving signals.

Optionally, in one or more example embodiments, the security module 428 secures interactions between the controller 304, the users 150 (including associated user systems 155), the other communication apparatuses 170, the network manager 180, and the objects 175 (including associated detectors 185). More specifically, the security module 428 authenticates communication from software based on security keys verifying the identity of the source of the communication. For example, user software may be associated with a security key enabling the software of a user system 155 to interact with the controller 304. Further, the security module 428 can restrict receipt of information, requests for information, and/or access to information.

A user 150 (including an associated user system 155), the other communication apparatuses 170, the network manager 180, and the objects 175 (including any associated detectors 185) can interact with the controller 304 of a communication apparatus 170 using the application interface 426 in accordance with one or more example embodiments. Specifically, the application interface 426 of the controller 304 receives data (e.g., information, communications, instructions, updates to firmware) from and sends data (e.g., information, communications, instructions) to the user systems 155 of the users 150, the other communication apparatuses 170, the network manager 180, and/or the objects 175 (including any associated detectors 185). Examples of an application interface 426 can be or include, but are not limited to, an application programming interface, a keyboard, a web service, a data protocol adapter, some other hardware and/or software, or any suitable combination thereof. Similarly, the user systems 155 of the users 150, the other communication apparatuses 170, the network manager 180, and/or the objects 175 (including any associated detectors 185) can include an interface (similar to the application interface 426 of the controller 304 of the communication apparatus 170) to receive data from and send data to the controller 304 in certain example embodiments.

In some cases, a user system 155 of a user 150, one or more of the other communication apparatuses 170, the network manager 180, and/or one or more of the objects 175 (including any associated detectors 185) can include a user interface. Examples of such a user interface can include, but are not limited to, a graphical user interface, a touchscreen, a keyboard, a monitor, a mouse, some other hardware, or any suitable combination thereof.

The controller 304 of a communication apparatus 170, the users 150 (including associated user systems 155), the other communication apparatuses 170, the network manager 180, and the objects 175 (including any associated detectors 185) can use their own system or share a system in certain example embodiments. Such a system can be, or contain a form of, an Internet-based or an intranet-based computer system that is capable of communicating with various software. A computer system includes any type of computing device and/or communication device, including but not limited to the controller 304. Examples of such a system can include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 5.

Further, as discussed above, such a system can have corresponding software (e.g., user software, sensor software, controller software, network manager software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wire and/or wireless segments according to some example embodiments. The software of one system can be a part of, or operate separately but in conjunction with, the software of another system within the system 100.

The volume of space 109 in which example communication apparatuses 170 can be situated in one or more of any of a number of environments. Examples of such environments can include, but are not limited to, indoors, outdoors, a convention center, a retail store (e.g., a grocery store, a furniture store, a convenience store), an office space, a conference room, a factory floor, a park, and a farmer's market, any of which can be climate-controlled or non-climate-controlled. An example communication apparatus can be integrated with or into any of a number of different structures. Such structures can include, but are not limited to, a ceiling, a floor, a pole, an I-beam, drywall, wood studs, a tree, a wall, and a building facade.

FIG. 5 illustrates one embodiment of a computing device 518 that implements one or more of the various techniques described herein, and which is representative, in whole or in part, of the elements described herein pursuant to certain example embodiments. For example, the controller 304 of a communication apparatus 170 (including components thereof, such as the control engine 406, the hardware processor 420, the storage repository 430, the power supply 440, and the transceiver 424) can be considered a computing device 518. Computing device 518 is one example of a computing device and is not intended to suggest any limitation as to scope of use or functionality of the computing device and/or its possible architectures. Neither should the computing device 518 be interpreted as having any dependency or requirement relating to any one or combination of components illustrated in the example computing device 518.

The computing device 518 includes one or more processors or processing units 514, one or more memory/storage components 515, one or more input/output (I/O) devices 516, and a bus 517 that allows the various components and devices to communicate with one another. The bus 517 represents one or more of any of several types of bus structures, including a memory bus or memory controller, a peripheral bus, an accelerated graphics port, and a processor or local bus using any of a variety of bus architectures. The bus 517 includes wired and/or wireless buses.

The memory/storage component 515 represents one or more computer storage media. The memory/storage component 515 includes volatile media (such as random access memory (RAM)) and/or nonvolatile media (such as read only memory (ROM), flash memory, optical disks, magnetic disks, and so forth). The memory/storage component 515 includes fixed media (e.g., RAM, ROM, a fixed hard drive, etc.) as well as removable media (e.g., a Flash memory drive, a removable hard drive, an optical disk, and so forth).

One or more I/O devices 516 allow a user 150 to enter commands and information to the computing device 518, and also allow information to be presented to the user 150 and/or other components or devices. Examples of input devices 516 include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 518 is connected to a network (not shown) (e.g., a LAN, a WAN such as the Internet, cloud, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer device 518 includes at least the minimal processing, input, and/or output means necessary to practice one or more embodiments.

Further, those skilled in the art will appreciate that one or more elements of the aforementioned computer device 518 is located at a remote location and connected to the other elements over a network in certain example embodiments. Further, one or more embodiments is implemented on a distributed system having one or more nodes, where each portion of the implementation (e.g., a user system 155, a communication apparatus 170, the network manager 180) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

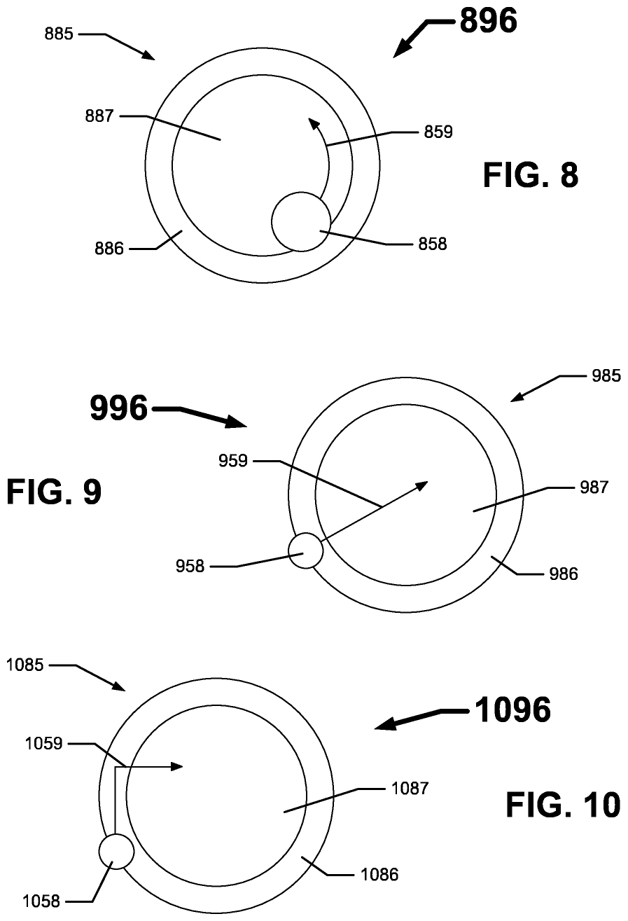

FIG. 6 shows a flowchart 698 of a method for tracking multiple objects in a volume of space according to certain example embodiments. While the various steps in this flowchart 698 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order.

In addition, a person of ordinary skill in the art will appreciate that additional steps not shown in FIG. 6 may be included in performing this method. Accordingly, the specific arrangement of steps should not be construed as limiting the scope. Further, a particular computing device, such as the computing device discussed above with respect to FIG. 5, can be used to perform one or more of the steps for the methods shown in FIG. 6 in certain example embodiments. Any of the functions performed below by the controller 304 can involve the use of one or more protocols 432, one or more algorithms 433, and/or stored data 434.

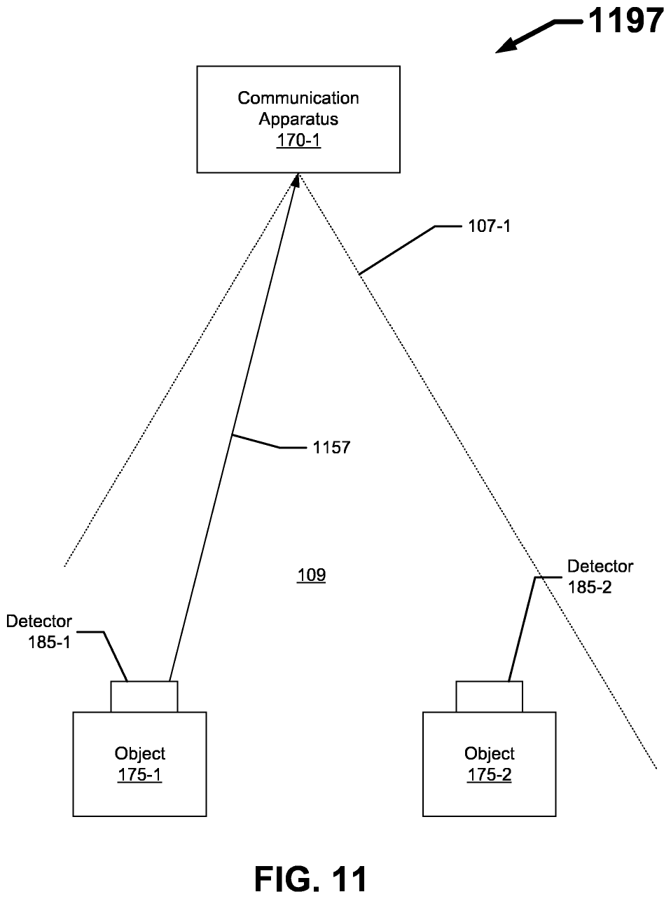

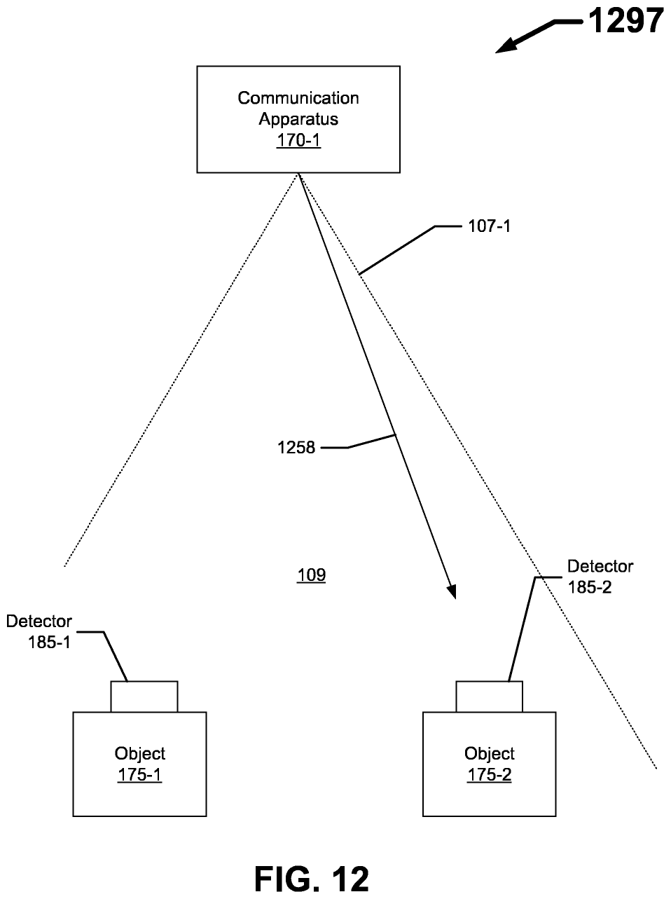

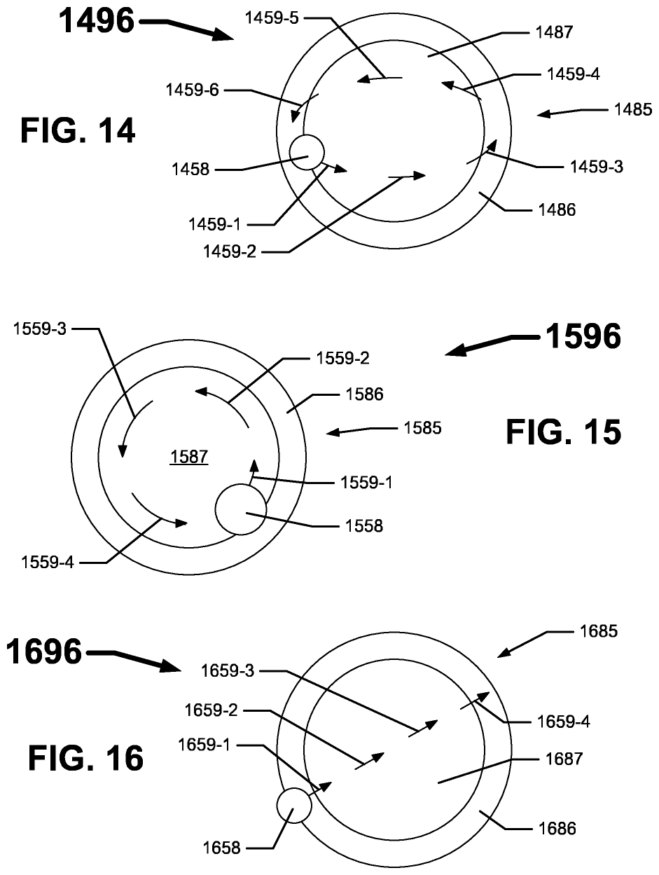

The method shown in FIG. 6 is merely an example that can be performed by using an example system described herein. In other words, systems for tracking multiple objects in a volume of space can perform other functions using other methods in addition to and/or aside from those shown in FIG. 6. To assist in illustrating the method shown in FIG. 6, FIGS. 7 through 16 are used. FIGS. 7 and 11 through 13 show various steps of the method within a cycle of tracking multiple objects in a volume of space. FIGS. 8 through 10 each show movement of a light signal relative to a detector within part of a cycle. FIGS. 14 through 16 each show an interaction between a light signal and a detector during a complete cycle.

Referring to FIGS. 1 through 16, the method shown in the flowchart 698 of FIG. 6 begins at the START step and proceeds to step 681, where a cycle is initiated. A cycle can be initiated by the controller (e.g., controller 304) of a communication apparatus (e.g., communication apparatus 170-1) using measurements from one or more sensor devices 360, one or more algorithms 433, and/or one or more protocols 432. A cycle refers to a completion of a single locational path of movement or a series of locational paths of movement that form a geometric entity (e.g., a circle, an ellipse, a line, a square, a hexagon, a spiral, an irregular closed shape, an irregular open shape) with respect to a light signal 158 directed to each of multiple detectors 185 (and so also multiple objects 175) in a portion of the volume of space 109.

As defined herein, a locational path of movement describes the path of a light signal 158 that is directed to (transmitted toward) a series of locations that are proximate to each other within the light signal range 107 in the volume of space 109. The controller 304 approximates a locational path of movement in the volume of space 109 to coincide with the location of a detector 185 at a point in time. The locational path of movement of a light signal 158 can be established, maintained, altered, cancelled, and/or changed by the controller 304 of a communication apparatus 170. More information about cycles, and portions thereof, are discussed below.

Initiating a cycle can include use of the timer 410. Initiating a cycle can include defining one or more of a number of characteristics of the cycle and/or the light signals 158. Examples of such characteristics can include, but are not limited to, a start time of the cycle, a number of objects 175 to track within the light signal range 107 within the volume of space 109 (also called the portion 107 of the volume of space 109), the total duration of the cycle, the locational path of movement of the light signal 158 for each object 175, the number of breaks in the locational path of movement of the light signal 158 for each object 175, the duration of each break in the locational path of movement of the light signal 158 for each object 175, the number of light signals 158 sent toward an object 175 in the cycle, and the distribution of light signals 158 sent toward an object 175 in the cycle. A cycle can be any amount of time (e.g., 10 seconds, 10 milliseconds, 9 nanoseconds). The length of a cycle can be constant or adjusted (e.g., by a controller 304) from one cycle to the next cycle.

In step 682, a light signal (e.g., light signal 158) is transmitted in a locational path of movement within the portion (e.g., light signal range 107-1) of the volume of space 109 toward the object 175 (e.g., object 175-1). The locational path of movement can be continuous and correspond to a series of targets of the light signal within the light signal range 107-1 in the volume of space 109. Target locational paths of movement can correspond to a series of targets of the plurality of light signals within the volume of space. FIG. 7 shows a snapshot in time of this step in the method. Specifically, FIG. 7 shows a portion 797 of the system 100 of FIG. 1. The portion 797 of the system shown in FIG. 7 includes the communication apparatus 170-1, the object 175-1, and object 175-2 in the volume of space 109. Object 175-1 includes the detector 185-1, and object 175-2 includes detector 185-2. Object 175-1 and object 175-2 fall within the light signal range 107-1 within (also called a portion 107-1 of) the volume of space 109. At the point in time shown in FIG. 7, the communication apparatus 170-1 is sending a light signal 758 toward detector 185-1 of object 175-1.

FIGS. 8 through 10 show examples of paths of movement within the first portion (e.g., light signal range 107-1) of the volume of space 109 toward which the light signal 158 can be transmitted. Specifically, FIG. 8 shows a subsystem 896 that includes a detector 885 (which is substantially similar to detector 185-1), a light signal 858 (which is substantially similar to light signal 158), and the locational path of movement 859 of the light signal 858. The locational path of movement 859 of the light signal 858 is continuous along its length. In this example, the locational path of movement 859 of the light signal 858 forms an arc of part of a circle. The locational path of movement 859 lasts for a time period within a cycle.

In certain example embodiments, the rate at which the light signal 858 travels along the locational path of movement 859 is faster than the rate at which the object 175 (e.g., object 175-1) associated with the detector 885 moves. Along the entire locational path of movement 859, part of the light signal 858 contacts the retroreflector 886 of the detector 885, and the remainder of the light signal 858 contacts the detector body 887 of the detector 885. In this way, the portion of the light signal 858 that contacts the retroreflector 886 of the detector 885 can be returned to the communication apparatus 170-1 as a reflected signal 1157, as discussed below. As described herein any locational path of movement (e.g., locational path of movement 859) is continuous for the duration of the time period within the cycle. In other words, the light beam 158 is moving throughout the time period in which the locational path of movement is active. The movement of the light beam 158 along a locational path of movement can be constant or variable during the time period of the cycle.

FIG. 9 shows a subsystem 996 that includes a detector 985 (which is substantially similar to detector 185-1), a light signal 958 (which is substantially similar to light signal 158), and the locational path of movement 959 of the light signal 958. The locational path of movement 959 of the light signal 958 is continuous along its length. In this example, the locational path of movement 959 of the light signal 958 forms a line segment. The locational path of movement 959 lasts for a time period within a cycle.

In certain example embodiments, the rate at which the light signal 958 travels along the locational path of movement 959 is faster than the rate at which the object (e.g., object 175-1) associated with the detector 985 moves. Along the entire locational path of movement 959, part of the light signal 958 contacts the retroreflector 986 of the detector 985, and the remainder of the light signal 958 contacts the detector body 987 of the detector 985. In this way, the portion of the light signal 958 that contacts the retroreflector 986 of the detector 985 can be returned to the communication apparatus 170-1 as a reflected signal 1157, as discussed below.

FIG. 10 shows a subsystem 1096 that includes a detector 1085 (which is substantially similar to detector 185-1), a light signal 1058 (which is substantially similar to light signal 158), and the locational path of movement 1059 of the light signal 1058. The locational path of movement 1059 of the light signal 1058 is continuous along its length. In this example, the locational path of movement 1059 of the light signal 1058 forms an “L” shape, as with a corner of a square or rectangle. The locational path of movement 1059 lasts for a time period within a cycle. In alternative embodiments, the locational path of movement of a light signal can form one or more angles that are different than (e.g., more than, less than) 90°.

In certain example embodiments, the rate at which the light signal 1058 travels along the locational path of movement 1059 is faster than the rate at which the object (e.g., object 175-1) associated with the detector 1085 moves. Along the entire locational path of movement 1059, part of the light signal 1058 contacts the retroreflector 1086 of the detector 1085, and the remainder of the light signal 1058 contacts the detector body 1087 of the detector 1085. In this way, the portion of the light signal 1058 that contacts the retroreflector 1086 of the detector 1085 can be returned to the communication apparatus 170-1 as a reflected signal 1157, as discussed below.

The light signal 758 can be transmitted using a transmitter (e.g., a transmitter 324) of the communication apparatus 170-1. The controller 304 of the communication apparatus 170-1 can determine and implement characteristics of the light signal 758. Such characteristics can include, but are not limited to, the diameter of the light signal 758, the intensity of the light signal 758, the shape of the locational path of movement (e.g., locational path of movement 859) of the light signal 758, the speed of travel of the light signal 758 along the locational path of movement, the distance of the locational path of movement, and the starting and ending points of the light signal 758 along the locational path of movement relative to the detector 185-1. The controller 304 can transmit the light signal 758 toward the detector 185-1 using one or more algorithms 433 and/or one or more protocols 432.

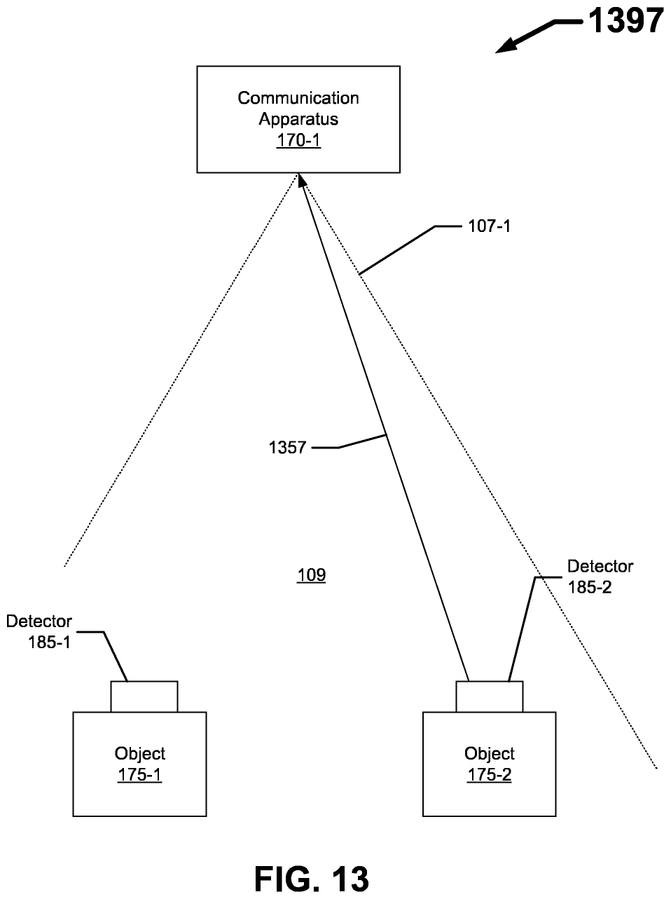

In step 683, a reflected signal is received from the detector of the object. FIG. 11 shows a snapshot in time of this step in the method. Specifically, FIG. 11 shows a portion 1197 of the system 100 of FIG. 1. The portion 1197 of the system shown in FIG. 11 is identical (in terms of components) as the portion 797 of FIG. 7, which includes the communication apparatus 170-1, the object 175-1, and the object 175-2 in the volume of space 109. Object 175-1 includes the detector 185-1, and object 175-2 includes the detector 185-2. Object 175-1 and object 175-2 fall within the light signal range 107-1 within (also called a portion 107-1 of) the volume of space 109. At the point in time shown in FIG. 11, the communication apparatus 170-1 is receiving a reflected signal 1157, which is a reflection of the light signal 758, from the detector 185-1 of object 175-1.

The light signal 1158 can be received by one or more of the receivers (e.g., receiver 373) of the communication apparatus 170-1. The controller 304 can control, using one or more algorithms 433, one or more protocols 432, and/or measurements from one or more sensor devices 360, one or more of the receivers 373 to ensure and/or optimize receipt of the reflected signal 1157. In certain example embodiments, the reflected signal 1157 does not contain any data or other information that allows the controller 304 to specifically identify the object 175-1. In other words, while the controller 304 can track the object 175-1 using a self-established identifier, example embodiments for tracking the object 175-1, as well as the other objects 175 in the volume of space 109, do not receive or otherwise establish an identify of the object 175-1 using the reflected signal 1157. Such identification of the objects 175 can occur independently, as with a separate signal transmitted by the object 175 after the detector body (e.g., detector body 287) receives part of the light signal 1158 from the communication apparatus 170-1.

In step 684, the current position and the path of the object 175-1 is determined. In other words, the object 175-1 is tracked. The position and path of the object 175-1 can be based on the reflected signal 1157 received from the detector 185-1 of the object 175-1. The current position and the path of the object 175-1 can determined by the controller 304 of the communication apparatus 170-1 using one or more algorithms 433, one or more protocols 432, and/or measurements from one or more sensor devices 360. In some cases, the controller 304 can determine that the object 175-1 is stationary.

In any case, tracking the object 175-1 (e.g., determining the current position and path of the object 175-1, predicting the location of the object 175-1 in the volume of space 109 at a point in time) can cause the controller 304 to adjust one or more of the algorithms 433, one or more of the protocols 432, and/or one or more of the tables (part of the stored data 434) associated with the object 175-1 and apply those changes to the next part of the cycle directed to tracking the object 175-1. For example, the controller 304 can compare predicted movement of the object 175-1 over time with actual movement of the object 175-1. As a result, the controller 304 can adjust one or more algorithms 433 used to predict movement of the object 175-1. As another example, the controller 304 can determine, using one or more algorithms 433 and measurements from one or more sensor devices 360, the optimal characteristics of the light signal 158 based on the relation between the direction of the light signal 158 transmitted by a transmitter 324 and the direction of the reflected signals 157 that are received by one or more of the receivers 373 while varying the direction of the light signal 158.

As still another example, the controller 304 can determine, using one or more algorithms 433 and measurements from one or more sensor devices 360, the optimal time division of the light signals 158 directed toward the various objects 175 in the portion 107-1 of the volume of space 109. Such a determination can be made, for example, based on the predictability of movement of an object 175, where more uncertainty requires more alignment information, and on the required communication bandwidth, where low data rates result in short time slots for the collection of information from the reflected signals 147. For an object 175 that the controller 304 has determined is moving more quickly within the volume of space 109, the controller 304 can make adjustments so that the number of locational paths of movement (e.g., locational path of movement 859) in a cycle increases and the duration of each of the paths of movement in the cycle is shortened. As yet another example, the controller 304 can determine, using one or more algorithms 433 and measurements from one or more sensor devices 360, how to optimize the shape/size of the light signal 158 transmitted toward a particular object 175, where a light signal 158 can have a larger diameter when the particular object 175 is static or moving very slowly.

Determining the current position and path of the object 175-1 can be important for one or more of a number of reasons. For example, in order to have the quality of the light signals 158 (and so also the reflected signals 157) be as healthy as possible, thereby avoiding data and/or communication loss, the light signals 158 should be transmitted, as much as possible, at the detector 185 of each object 175. Because the object 175, the light signals 158 (as during the paths of movement), and/or other components (e.g., the communication apparatus 170) of the system 100 are moving, vibrating, displaced, etc., the algorithms 433 used for tracking the objects 175 need to be updated as soon as possible before the light signals 158 miss hitting the detectors 185 of the objects 175, which would cause the signal-to-noise ratio to fall below acceptable operational levels.

In step 688, a determination is made as to whether the cycle is complete. The determination as to whether a cycle is complete can be made by the controller 304 of the communication apparatus 170-1 using one or more algorithms 433, one or more protocols 432, and/or measurements from one or more sensor devices 360. One or more of a number of factors can help determine whether a cycle is complete. Examples of such factors can include, but are not limited to, passage of time, whether reflected signals (e.g., reflected signal 1157) have been received from all known objects 175 in the portion 107-1 of the volume of space 109, and the number of reflected signals received from each of the known objects 175 in the portion 107-1 of the volume of space 109. If the cycle is complete, then the process proceeds to step 691. If the cycle is not complete, then the process proceeds to step 689.

In step 689, preparations are made to track the next object 175 in the portion 107-1 of the volume of space 109. This process of using a light beam from a single transmitter 324 to track multiple objects 175 within a cycle can be referred to as time division. These preparations can be made by the controller 304 of the communication apparatus 170-1 using one or more algorithms 433, one or more protocols 432, and/or measurements from one or more sensor devices 360. Such preparations can include, but are not limited to, adjusting (e.g., changing a position and/or other settings of) a transmitter 324, adjusting an optical device 374, and accessing a new data table in the storage repository 330 that corresponds to the next object 175 to be tracked. For purposes of this discussion, when the communication apparatus 170-1 has multiple transmitters 324, the same transmitter 324 is used to direct a light signal 157 toward multiple objects 175 in the portion 107-1 of the volume of space 109 at different intervals of time within a cycle. When step 689 is complete, the process reverts to step 682.

FIG. 12 shows a snapshot in time in the method when another object 175 is tracked. Specifically, FIG. 12 shows a portion 1297 of the system 100 of FIG. 1. The portion 1297 of the system shown in FIG. 12 includes the communication apparatus 170-1, the object 175-1, and the object 175-2 in the volume of space 109. Object 175-1 includes the detector 185-1, and object 175-2 includes detector 185-2. Object 175-1 and object 175-2 fall within the portion 107-1 the volume of space 109. At the point in time shown in FIG. 12, the communication apparatus 170-1 is sending a light signal 1258 toward detector 185-2 of object 175-2. This is a reapplication of step 682 with respect to a different object 175 (in this case, object 175-2 as opposed to object 175-1) compared to a prior part of the cycle. FIG. 13 shows a portion 1397 of the system 100 of FIG. 1. The portion 1397 of the system shown in FIG. 13 is identical (in terms of components) as the portion 1297 of FIG. 12, which includes the communication apparatus 170-1, the object 175-1, and the object 175-2 in the volume of space 109. Object 175-1 includes the detector 185-1, and object 175-2 includes the detector 185-2. Object 175-1 and object 175-2 fall within the light signal range 107-1 within (also called a portion 107-1 of) the volume of space 109. At the point in time shown in FIG. 13, the communication apparatus 170-1 is receiving a reflected signal 1357, which is a reflection of the light signal 1258, from the detector 185-2 of object 175-2. This is a reapplication of step 683 with respect to a different object 175 (in this case, object 175-2 as opposed to object 175-1) compared to a prior part of the cycle.

FIGS. 14 through 16 show examples of multiple locational paths of movement within the first portion (e.g., light signal range 107-1) of the volume of space 109 toward which the light signal 158 can be transmitted over the course of a complete cycle. Specifically, FIG. 14 shows a subsystem 1496 that includes a detector 1485 (which is substantially similar to detector 185-1), a light signal 1458 (which is substantially similar to light signal 158), and six locational paths of movement 1459 of the light signal 1458 in a complete cycle. Each locational path of movement 1459 of the light signal 1458 is continuous along its length. In this example, each of the six locational paths of movement 1459 (locational path of movement 1459-1, locational path of movement 1459-2, locational path of movement 1459-3, locational path of movement 1459-4, locational path of movement 1459-5, and locational path of movement 1459-6) of the light signal 1458 forms an arc of part of an ellipse. Each of the locational paths of movement 1459 lasts for a time period within a cycle.

The time period for each locational path of movement 1459 in this case is substantially the same, but in alternative embodiments, the time period of one locational path of movement 1459 can differ from one or more of the other locational paths of movement 1459 within a cycle. In general, the gaps between adjacent locational paths of movement (e.g., locational path of movement 1459-1 and locational path of movement 1459-2) can be caused by the light signal being directed from the communication apparatus 170-1 toward another object 175 in the portion 107 of the volume of space 109. Alternatively, a gap between adjacent locational paths of movement can be caused by some other consideration, such as conservation of resources. In some cases, the controller 304 of the communication apparatus 170-1, using one or more protocols 432 and/or one or more algorithms 433, can make one or more alterations (e.g., change the shape/pace/duration of one or more of the locational paths of movement, change the size and/or location of the gaps between adjacent locational paths of movement, change the number of locational paths of movement in a cycle) during the course of a cycle.

Along locational path of movement 1459-1, locational path of movement 1459-3, locational path of movement 1459-4, and locational path of movement 1459-6, part of the light signal 1458 contacts the retroreflector 1486 of the detector 1485, and the remainder of the light signal 1458 along those locational paths of movement 1459 contacts the detector body 1487 of the detector 1485. Along locational path of movement 1459-2 and locational path of movement 1459-5, none of the light signal 1458 contacts the retroreflector 1486 of the detector 1485, and all of the light signal 1458 along those locational paths of movement 1459 contacts the detector body 1487 of the detector 1485. In this way, the portion of the light signal 1458 that contacts the retroreflector 1486 of the detector 1485 can be returned to the communication apparatus 170-1 as a reflected signal.

FIG. 15 shows a subsystem 1596 that includes a detector 1585 (which is substantially similar to detector 185-1), a light signal 1558 (which is substantially similar to light signal 158), and four locational paths of movement 1559 of the light signal 1558 in a complete cycle. Each locational path of movement 1559 of the light signal 1558 is continuous along its length. In this example, each of the four locational paths of movement 1559 (locational path of movement 1559-1, locational path of movement 1559-2, locational path of movement 1559-3, and locational path of movement 1559-4) of the light signal 1558 forms an arc of part of a circle.

The time period for each locational path of movement 1559 in this case is substantially the same, but in alternative embodiments, the time period of one locational path of movement 1559 can differ from one or more of the other locational paths of movement 1559 within a cycle. The gaps between adjacent locational paths of movement 1559 can be caused by the light signal being directed from the communication apparatus 170-1 toward another object 175 in the portion 107 of the volume of space 109. Alternatively, a gap between adjacent locational paths of movement 1559 can be caused by some other consideration, such as conservation of resources.

Along locational path of movement 1559-1, locational path of movement 1559-2, locational path of movement 1559-3, and locational path of movement 1559-4, part of the light signal 1558 contacts the retroreflector 1586 of the detector 1585, and the remainder of the light signal 1558 along those locational paths of movement 1559 contacts the detector body 1587 of the detector 1585. In this way, the portion of the light signal 1558 that contacts the retroreflector 1586 of the detector 1585 can be returned to the communication apparatus 170-1 as a reflected signal.

FIG. 16 shows a subsystem 1696 that includes a detector 1685 (which is substantially similar to detector 185-1), a light signal 1658 (which is substantially similar to light signal 168), and four locational paths of movement 1659 of the light signal 1658 in a complete cycle. Each locational path of movement 1659 of the light signal 1658 is continuous along its length. In this example, each of the four locational paths of movement 1659 (locational path of movement 1659-1, locational path of movement 1659-2, locational path of movement 1659-3, and locational path of movement 1659-4) of the light signal 1658 forms a segment of part of a line.

The time period for each locational path of movement 1659 in this case is substantially the same, but in alternative embodiments, the time period of one locational path of movement 1659 can differ from one or more of the other locational paths of movement 1659 within a cycle. The gaps between adjacent locational paths of movement 1659 can be caused by the light signal being directed from the communication apparatus 170-1 toward another 4 object 175 in the portion 107 of the volume of space 109. Alternatively, a gap between adjacent locational paths of movement 1659 can be caused by some other consideration, such as conservation of resources.

Along locational path of movement 1659-1 and locational path of movement 1659-4, part of the light signal 1658 contacts the retroreflector 1686 of the detector 1685, and the remainder of the light signal 1658 along those locational paths of movement 1659 contacts the detector body 1687 of the detector 1685. Along locational path of movement 1659-2 and locational path of movement 1659-3, none of the light signal 1658 contacts the retroreflector movement 1659 contacts the detector body 1687 of the detector 1685. In this way, the portion of the light signal 1658 that contacts the retroreflector 1686 of the detector 1685 can be returned to the communication apparatus 170-1 as a reflected signal.

In step 691, a determination is made as to whether the method should continue with a new cycle. The determination as to whether the method should continue with a new cycle can be made by the controller 304 of the communication apparatus 170-1 using one or more algorithms 433, one or more protocols 432, and/or measurements from one or more sensor devices 360. The determination can be based on one or more of a number of factors, including the factors listed above with respect to step 681 and whether any objects 175 remain in the portion 107 of the volume of space 109.

In some cases, if the determination is to continue the method with a new cycle, the controller 304 can adjust (e.g., increase, decrease) the amount of time that a cycle lasts. For example, if the controller 304 determines that multiple objects 175 in the volume of space 109 are moving at a faster pace than previously measured and/or predicted, then the controller 304 can increase the amount of time in a cycle so that light signals in a larger number of locational paths of movement of shorter duration can be directed toward the detectors 185 of the objects 175. If the method of tracking objects 175 in the volume of space 109 should continue with a new cycle, the process can revert to step 681. If the method of tracking objects 175 in the volume of space 109 should not continue with a new cycle, the process proceeds to the END step.

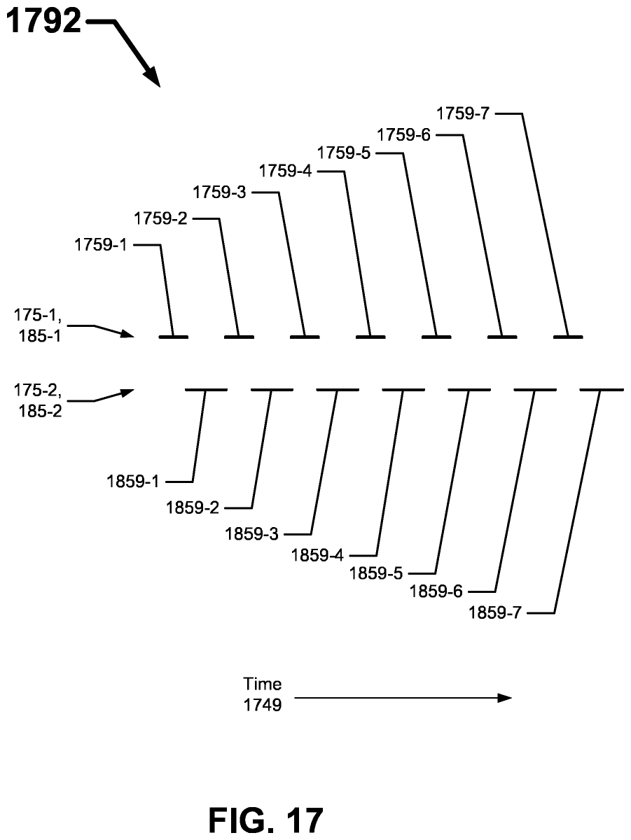

FIG. 17 shows a graph 1792 of a light signal (e.g., light signal 158) transmitted toward two objects (object 175-1 and object 175-2) during a cycle according to certain example embodiments. Referring to FIGS. 1 through 17, the graph 1792 of FIG. 17 shows how the light signals transmitted by a transmitter (e.g., a transmitter 324) of a communication apparatus (e.g., communication apparatus 170-1) are distributed over the course of a cycle (time 1749). During the cycle, seven light signals are directed toward the detector 185-1 of object 175-1, and seven other light signals are directed toward the detector 185-2 of object 175-2. There is no overlap between when the light signals are directed to one detector 185 (e.g., detector 185-1) as opposed to the other detector 185 (e.g., detector 185-2). Also, there is a negligible time gap when the light signal transitions from one detector 185 to the other detector 185.

For each amount of time 1749 within the cycle, a light signal is transmitted toward detector 185-1 about 50% less than the amount of time 1749 that each of the light signals are transmitted toward detector 185-2. Each instance when a light signal is transmitted toward detector 185-1 corresponds to a locational path of movement 1759. As a result, the seven instances when the light signal is transmitted toward the detector 185-1 during the cycle corresponds to locational path of movement 1759-1, locational path of movement 1759-2, locational path of movement 1759-3, locational path of movement 1759-4, locational path of movement 1759-5, locational path of movement 1759-6, and locational path of movement 1759-7. Similarly, each instance when a light signal is transmitted toward detector 185-2 corresponds to a locational path of movement 1859. As a result, the seven instances when the light signal is transmitted toward the detector 185-2 during the cycle corresponds to locational path of movement 1859-1, locational path of movement 1859-2, locational path of movement 1859-3, locational path of movement 1859-4, locational path of movement 1859-5, locational path of movement 1859-6, and locational path of movement 1859-7.

Example embodiments can be used to track one or more objects in a volume space in real time. Example embodiments can be implemented on existing systems (e.g., lighting systems) within a volume of space with little to no modification required to the electrical equipment of such existing systems. Example embodiments can be implemented with new installations of electrical equipment as well as easily installing, retrofitting, or replacing electrical equipment. Example embodiments also provide a number of other benefits. Such other benefits can include, but are not limited to, ease of use, increased accuracy and efficiency, lower power and bandwidth requirements, and compliance with industry standards and regulations.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. A method for tracking an object in a volume of space, the method comprising:
transmitting, by a communication apparatus during a first time period, a first light signal toward the object located in the volume of space, wherein the first light signal is transmitted along a locational path of movement within the volume of space during the first time period, wherein the locational path of movement corresponds to a path the first light signal travels within the volume of space during the first time period;
receiving, by the communication apparatus, a first reflected signal during the first time period, wherein the first reflected signal is a reflection of the first light signal that originates from a reflective device of the object;
transmitting, by the communication apparatus during a second time period, a second light signal toward the object located in the volume of space, wherein the second light signal is transmitted along the locational path of movement within the volume of space during the second time period, wherein the locational path of movement corresponds to a path the second light signal travels within the volume of space during the second time period, wherein the second time period proceeds the first time period, and wherein the first time period and the second time period are separated from each other by a non-zero time interval;
receiving, by the communication apparatus, a second reflected signal during the second time period, wherein the second reflected signal is a reflection of the second light signal that originates from the reflective device of the object; and
determining, using the communication apparatus, a location and a path of the object in the volume of space based on first information obtained from the first reflected signal and second information obtained from the second reflected signal.

2. The method of claim 1, wherein the first information comprises a strength of the first reflected signal.

3. The method of claim 1, wherein the locational path of movement forms an arc.

4. The method of claim 1, wherein the first light signal is transmitted continuously along the locational path of movement during the first time period.

5. The method of claim 1, further comprising:
transmitting, by the communication apparatus during a third time period, a third light signal toward a second object located in the volume of space, wherein the third light signal is transmitted in a second locational path of movement within the volume of space during the third time period, and wherein the third time period occurs during the non-zero time interval;
receiving, by the communication apparatus, a third reflected signal during the third time period, wherein the third reflected signal is a reflection of the third light signal that originates from a second reflective device of the second object; and
determining, using the communication apparatus, a second location and a second path of the second object in the volume of space based on third information obtained from the second reflected signal.

6. The method of claim 1, further comprising:
transmitting, by the communication apparatus during a third time period, a third light signal toward the first object located in the volume of space, wherein the third light signal is transmitted in the first locational path of movement within the volume of space during the third time period, and wherein the third time period proceeds the second time period, and wherein the second time period and the third time period are separated from each other by second a non-zero time interval;
failing to receive, by the communication apparatus, a third reflected signal that originates from the first reflective device of the first object during the third time period; and
further determining, using the communication apparatus, the location and the path of the first object in the volume of space based on failing to receive the third reflected signal.

7. The method of claim 1, further comprising:
transmitting, by the communication apparatus during a third time period, a third light signal toward the object located in the volume of space, wherein the third light signal is transmitted in the first locational path of movement within the volume of space during the third time period, and wherein the third time period proceeds the second time period, and wherein the second time period and the third time period are separated from each other by second a non-zero time interval;
receiving, by the communication apparatus, a third reflected signal during the third time period, wherein the third reflected signal is a reflection of the third light signal that originates from the reflective device of the object; and
confirming, using the communication apparatus, that the object remains fixedly located in the volume of space based on third information obtained from the third reflected signal.

8. The method of claim 1, further comprising:
comparing predicted movement of the object over time with actual movement; and
adjusting, based on comparing the predicted movement with the actual movement, an algorithm for predicting movement of the object.

9. A communication apparatus for tracking an object in a volume of space, the communication apparatus comprising:
a transmitter that is configured to send a plurality of light signals into the volume of space;
a receiver that is configured to receive a plurality of reflected signals, wherein each of the plurality of reflected signals are reflections of one of the plurality of light signals that originate from a reflective device of the object; and
a controller communicably coupled to the transmitter and the receiver, wherein the controller is configured to:
control the transmitter to send each of the plurality of light signals along target locational paths of movement within the volume of space for one of a plurality of time periods in a cycle, wherein the target locational paths of movement correspond to paths of the plurality of light signals within the volume of space during respective ones of the plurality of time periods, wherein adjacent time periods when the plurality of light signals are sent toward the object are separated from each other by a non-zero time interval; and
determine, using information obtained from each of the plurality of reflected signals, a location and a path of the object in the volume of space during the cycle.

10. The communication apparatus of claim 9, wherein the controller is further configured to:
continue controlling the transmitter to send each of the plurality of light signals to target additional locational paths of movement within the volume of space for a time period in a subsequent cycle; and
continue determining, using information obtained from each of the plurality of reflected signals, the location and the path of the object in the volume of space in the subsequent cycle.

11. The communication apparatus of claim 10, wherein continuing controlling each of the plurality of light signals comprises adjusting a characteristic of at least one of the plurality of light signals in the subsequent cycle, and wherein the characteristic comprises at least one of a group consisting of an intensity of the light signal, a duration of the time period, a path of the objects by which the locational paths of movement are targeted, and a diameter of the light signal.

12. The communication apparatus of claim 9, further comprising:
an optical device communicably coupled to the controller, wherein the optical device is configured to manipulate the plurality of light signals sent by the transmitter into the volume of space.

13. The communication apparatus of claim 9, further comprising:
a sensor device communicably coupled to the controller, wherein the sensor device is configured to measure a parameter associated with the plurality of reflected signals, and wherein the information is derived from the parameter measured by the sensor device.

14. The communication apparatus of claim 9, wherein the locational paths of movement coincide with a predicted location of the plurality of objects.

15. The communication apparatus of claim 9, further comprising:
a housing configured to house the transmitter and the receiver.
